(19) United States
(12) Patent Application Publication
(10) Pub. No.: US 2005/0003968 A1
(43) Pub. Date: Jan. 6, 2005

(54) Drilling fluids

(76) Inventors: Hylke Hotze Simonides, Groningen (NL); Martinus Staal, Sappemeer (NL); Johannes Cornelis Petrus Hopman, Makkum (NL)

Correspondence Address: HOFFMANN & BARON, LLP, 6900 JERICHO TURNPIKE, SYOSSET, NY, 11791, US

(21) Appl. No.: 10/493,513

(22) PCT Filed: Oct. 21, 2002
(86) PCT No.: PCT/NL02/00665

(30) Foreign Application Priority Data
Oct. 26, 2001 (EP) 01204095.2

(51) Int. Cl. C09K 7/00; E21B 43/00

(52) U.S. Cl. 507/211; 507/110

(57) ABSTRACT

The invention relates to the field of drilling wells into a subterranean formation for the purpose of extracting or producing minerals contained by said formation. The invention specifically relates to drilling fluids used in such methods to form filter cakes for providing a sealing layer on the walls of boreholes formed by the drilling. A new bridging agent for use in such drilling fluids has been found, which has the great advantage that a good sealing filter cake is produced, which filter cake can be removed under very mild conditions.

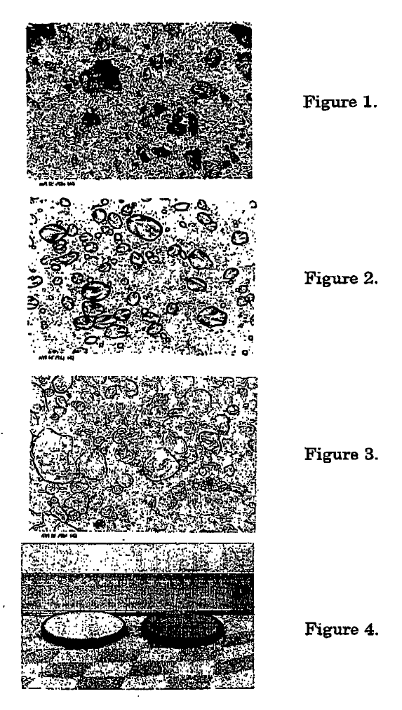

The invention relates to methods for drilling wells into subterranean formations containing gas, oil or other minerals for the purpose of extraction and production of said minerals. In particular, the invention relates to drilling fluids used in such methods and the use of starch in such fluids.

Drilling fluids used in methods for drilling production wells are often composed of water and a number of additives which can be chosen from a wide variety in various combinations to give a drilling fluid the characteristics required for the specific purposes for and circumstances under which the fluid is to be used. Drilling fluids are for example used to flush rock cuttings, stones, gravel, clay or sand torn loose by the drill bit to the surface or to clean and cool the drill bit. Another purpose is use for minimizing formation damage by lining or plastering the walls of the well bore to prevent caving in and to prevent invasion of solids and liquid into permeable formations, by bridging and sealing with drilling fluid components.

In this latter use of a drilling fluid, it typically comprises water, salts, polymers and solids. The solids are often referred to as bridging agents or bridging solids. An important function of the solids is to form an impermeable layer on the wall of a borehole preventing excessive invasion of fluids into the formation. This layer is usually referred to as the filter cake.

Typical examples of materials used as bridging agents in drilling fluids include properly graded or sized clays (e.g. bentonite or attapulgite clay), barite, calcium carbonate and sized sodium chloride in a saturated sodium chloride brine, or other that provide the desired solids content. Many of these materials also influence saturation, specific gravity, viscosity, plastering capacities and other properties of the drilling fluid. Particles of these materials seal the entrance to pores or fractures in the reservoir rock. They are typically used in combination with water soluble or colloidal polymers to enhance the seal. The polymers used may be selected on the basis that they should be degradable by acid or enzyme treatment to prevent them from reducing the permeability of the formation and facilitating removal of the filter cake.

The final step in drilling or completion of the mineral reservoirs usually is cleaning of the borehole with wash fluids. The purpose of cleaning is inter alia the removal of the filter cake. Filter cakes containing clay or barite have the disadvantage that they are generally difficult to remove. Accordingly, it is not preferred to use these materials as bridging agents in drilling fluids for drilling hydrocarbon formations.

Filter cakes containing sodium chloride particles are removed by washing with non-saturated solutions. A major disadvantage of sodium chloride as bridging agent is that it can only be used in solutions saturated in sodium chloride, which is a significant limitation on the scope of application of a drilling fluid. Also, removal of the filter cakes may require relatively large amounts of washing fluid.

If a drilling fluid is used which contains calcium carbonate as bridging agent, the filter cake formed by the fluid can be removed using strong acids. Remedial treatments for removal of calcium carbonate often involves the use of concentrated solutions of strong acids, such as 15% HCl solutions, which are expensive and can be hazardous. Moreover, strong acid treatment may be ineffective because zones of high permeability in the formation can channel the acid away into the formation, leaving the filter cake poorly dissolved and leading to formation damage. Strong acids may further cause corrosion of sand screens and downhole equipment.

GB 2,340,147 describes a wellbore fluid comprising a bridging agent composed of A) the reaction product of one or more water soluble organic compounds having a molecular weight of less than 30,000 and possessing at least two hydroxyl groups and B) any other organic compound(s) capable of forming acetal or hemi-acetal cross-links with the hydroxyl groups of compound A. It is stated that the acetal cross-links can be hydrolysed with acids, in such a way that the organic compounds with a molecular weight lower than 30,000 can dissolve. A particulate material based on high molecular weight materials, or a material in which the glucosidic bonds are hydrolysed with acids is not disclosed or suggested for use as bridging agent.

Society of Petroleum Engineers publication 18474 (1989) describes a non-damaging particulate fluid loss additive, consisting of a blend of various starches with a broad particle size distribution ranging from 5 to 200 microns and with a portion of the starch being water soluble. It is stated that the blend provides significantly lower spurt losses than the individual components. The blends consist of raw and pregelatinized cross-linked starches. The raw starches are present as fillers in the blend. In the native form they show an increase in diameter of <20% when dispersed in water, pregelatinized the increase in diameter is >50%. The pregelatinized cross-linked starches show water absorption of 10 times their own weight, corresponding with a diameter increase of over 50%. The publication does not disclose a water insoluble particulate material based on a cross-linked polysaccharide.

It is an object of the invention to provide a new alternative to the bridging agents conventionally employed in drilling fluids, which alternative does not suffer from the disadvantages of the conventional bridging agents as set forth above. More specifically, it is an object of the invention to provide a drilling fluid comprising a bridging agent, which fluid forms a filter cake which can be removed easily and effectively while using mild washing fluids. Of course, the filter cake should provide a good and impermeable seal in a borehole when needed during drilling. Furthermore, the objective new bridging agent should negatively impact the overall costs of a drilling fluid to an undesired extent. Other objects of the invention will become clear from the following detailed description of the invention.

Surprisingly, it has now been found that solid particles can be formed from a heavily cross-linked high molecular weight polysaccharide, which particles can be used as very efficient bridging agents in drilling fluids, thereby meeting the objectives mentioned above. Accordingly, the invention particularly relates to a bridging agent for a drilling fluid based on a polysaccharide which is cross-linked to such a degree that after gelatinization it forms solid particles which are substantially insoluble in water.

By incorporating a bridging agent according to the invention into a drilling fluid, a multi-purpose, economical, non-toxic and environmentally friendly drilling fluid may be provided. The use of this drilling fluid provides a highly efficient sealing layer on the walls of a borehole during the drilling of a well, preventing undesired invasion of fluids into the subterranean formation in which the well is drilled. Upon completion of the well, the filter cake providing the sealing layer can be easily removed under very mild conditions without the use of hazardous or environmentally unacceptable chemicals, allowing the minerals to flow into the borehole substantially without being hindered by the filter cake.

As mentioned, a bridging agent according to the invention is based on a polysaccharide. Many different polysaccharides can be used to form the present bridging agent from. Examples include cellulose, starch, tamarind, guar gum, and locust bean gum.

It is preferred that a bridging agent according to the invention is based on starch. In principle any starch obtained from any botanical source, be it a cereal, a fruit, a root or a tuber starch, can be used. Preferred starches include potato starch, corn starch, tapioca starch, wheat starch and rice starch. It is also possible to use a starch having an increased amylose or increased amylopectin content.

An important aspect of the invention is that the polysaccharide is cross-linked such that after gelatinization it has the form of a solid particulate material. The particles are amorphous and substantially insoluble in water under the conditions wherein they are used in a drilling fluid. Upon contact with the fluid, the particles swell due to the fact that they take up water. However, they only take up water in an amount approximately corresponding to a few times their own weight. Suspended in water the particles settle. The setting volume is a measure of the degree of cross-linking. Accordingly, when used in an aqueous environment, the particles essentially do not provide an increase in viscosity as normal cross-linked polysaccharides do. In this regard, it is important that the polysaccharide is cross-linked to a higher degree than commonly used. Although the necessary degree of cross-linking to achieve the desired particulate form depends on the nature of the polysaccharide, the type of cross-linking agent used and the conditions under which it will be used, generally the degree of cross-linking will be such that the setting volume of a 100 ml suspension containing 10% by weight (calculated on the suspension) of the cross-linked particulate material is to be below 70 ml, preferably below 40 ml.

Cross-linking, gelatinization and other modifications of the polysaccharide may in principle be carried out in any order. It is preferred, however, that the cross-linking and any other modifications (as will be discussed below) are performed prior to gelatinization.

In a cross-linking reaction, the polysaccharide is treated with a reagent, a crosslinking agent, having two or more reactive groups. The cross-linking agent is preferably attached to the polysaccharide via ester and/or ether linkages. Examples of suitable reactive groups are anhydride, halogen, halohydrin, epoxide groups, or combinations thereof. Epichlorohydrin, trimetaphosphate salts such as sodium trimetaphosphate, phosphorous oxychloride, phosphate salts, dimethylolethylene urea, adipic anhydride, dichloro acetic acid, and combinations thereof are preferred cross-linking agents in the context of the invention.

The cross-linking reaction may be carried out under any conditions which are known to be suitable for this type of reaction. Hence, it is possible to perform the reaction under semi-dry conditions, but also in a suspension of the polysaccharide in water or another suitable solvent, or in aqueous solution. By semi-dry conditions is meant that the moisture content during the reaction is below 10 wt. %, preferably below 5 wt. %, based on the weight of the reaction mixture.

It is preferred that the amount of cross-linking agent used relative to the amount of polysaccharide is such that the setting volume of a 100 ml suspension containing 10% by weight (calculated on the suspension) of the cross-linked particulate material is below 70 ml, preferably below 40 ml. The desired degree of cross-linking can typically be controlled by selecting a suitable amount of cross-linking reagent to be employed.

The amount of crosslinking agent necessary to obtain a bridging agent based on a cross-linked polysaccharide depends on the nature of the cross-link agent, the polysaccharide, reaction conditions and the composition of the drilling fluid. It is believed, however, that for cross-linking starch, the minimum amount of cross-link agent is at least 0.5 wt. % based on the weight of starch when the starch is cross-linked prior to gelatinization, about 20 times higher than the amount necessary for obtaining the maximum viscosity.

In order to provide a stabilized bridging agent, it may be preferred to hydroxyalkylate the polysaccharide. The alkyl chain of a hydroxyalkylating agent may vary from 1-20 carbon atoms, preferably from 1-12 carbon atoms, more preferably from 2-4 carbon atoms. Examples of suitable hydroxyalkylating agents include ethylene oxide, propylene oxide, butylene oxide, allyl glycidyl ether, propyl glycidyl ether, butyl glycidyl ether, and combinations thereof. Preferably, propylene oxide is used to hydroxyalkylate the starch. The polysaccharide can also be stabilized by carboxylation, for instance carboxymethylation. These modifications may be performed in any known manner. Examples of suitable manners for obtaining the desired derivatives are for instance disclosed in “Modified Starches: Properties and Uses”, O. B. Würzburg, CRC Press Inc., 1987.

Gelatinization of the polysaccharide may be performed in any known manner such as drum drying or extrusion.

Of course, the invention also encompasses a drilling fluid comprising a bridging agent as discussed above and the use of that drilling fluid in well drilling.

A drilling fluid according to the invention will generally be an aqueous composition comprising, in addition to the bridging agent, any conventional components. A bridging agent according to the invention will generally be present in a drilling fluid in an amount ranging from 30 to 150 g/l, preferably from 60 to 120 g/l. Other components of the drilling fluid may typically be a viscosifier, a fluid loss control additive, and/or soluble salts.

Examples of possible viscosifiers include Xanthan gum, scleroglucan gum, guar gum, hydroxyethyl cellulose (HEC), and synthetic polymers. Viscosifiers will typically be present in a drilling fluid according to the invention in an amount ranging from 1 to 9 g/L, preferably from 1.5 to 6 g/L.

Examples of possible fluid loss control additives include starch, modified starches, carboxymethyl cellulose (CMC), polyanionic cellulose (PAC), and polyacrylamides. These materials will typically be incorporated into a drilling fluid according to the invention in an amount of from 10 to 40 g/l, preferably from 15 to 30 g/l.

Examples of possible salts that can be included in a drilling fluid are sodium chloride, potassium chloride, calcium chloride, calcium bromide, zink chloride, zink bromide, sodium formate, potassium formate, cesium formate, sillicates in an amount up to their saturation concentration.

It is further possible to include an alkaline buffer in a drilling fluid according to the invention in an amount up to 30 g/l, depending on the specific circumstances under which the drilling fluid is to be used. Preferred amounts of an alkaline buffer lie in the range of 2 to 15 g/l. Suitable examples of alkaline buffers are magnesium oxide, and sodium hydrogen carbonate.

A drilling fluid according to the invention may be used in a method for drilling a well into a subterranean formation in a manner similar to those wherein conventional drilling fluids are used. In the process of drilling the well, a drilling fluid is circulated through the drill pipe, through the bit, and up the annular space between the pipe and the formation or steel casing to the surface. The drilling fluid performs several different functions, such as cooling the bit, removing drilled cuttings from the bottom of the hole, suspending the cuttings and weighting the material when the circulation is interrupted. In addition, the drilling fluid provides filtration control to prevent excessive loss of fluids into the formation.

Upon applying a drilling fluid according to the invention in a borehole, filter cake is formed which provides an effective sealing layer on the walls of the borehole preventing undesired invasion of fluid into the formation surrounding the borehole. Before taking the well into production, this filter cake is removed. It is one of the great advantages of the invention that a filter cake formed by using a drilling fluid according to the invention can be removed very easily and under very mild conditions.

A filter cake according to the invention may be removed using a washing fluid comprising a weakly acidic aqueous solution. Preferred examples of acids that can be used include strong mineral acids, such as hydrochloric acid or sulfuric acid, and organic acids, such as citric acid, lactic acid, malic acid, acetic acid, and formic acid. The washing fluid will typically have a pH below 4, preferably below 3. Alternatively, the filter cake may be removed using a washing liquid comprising e.g. a carbohydrate degrading enzyme. Preferred examples of such enzymes are amylases, pullulanases, and cellulases. In another embodiment, the filter cake may be removed using a washing liquid comprising an oxidizing agent, such as sodium hypochlorite.

The invention will now be further elucidated by the following, non-restrictive examples.

### EXAMPLE 1A

Synthesis of the Bridging Solid FCS

Starch was cross-linked in a 35% suspension in water containing NaCl with sodium trimetaphosphate (50 g/kg) at 35° C. using NaOH as catalyst. The product was dried at 35° C. with warm air.

### EXAMPLE 1B

Synthesis of the Bridging Solid FCGS

Starch was cross-linked in a 35% suspension in water with sodium trimetaphosphate (50 g/kg) at 40° C. using NaOH as catalyst. The resulting product was drum dried.

### EXAMPLE 1C

Synthesis of the Bridging solid SCS

Starch was cross-linked in a 35% suspension in water containing NaCl with sodium trimetaphosphate 5 g/kg at 35° C. using NaOH as catalyst. The product was dried at 35° C. with warm air

### EXAMPLE 1D

Synthesis of starch cross-linked to the maximum viscosity VSCS

Starch was cross-linked in a 35% suspension in water containing NaCl with sodium trimetaphosphate 0.2 g/kg at 35° C. using NaOH as catalyst. The product was dried at 35° C. with warm air.

### EXAMPLE 1E

Synthesis of the Bridging Solid CTS1

Tapioca starch was cross-linked in a 39% suspension in water containing NaCl with sodium trimetaphosphate (50 g/kg) at 35° C. using NaOH as catalyst. The resulting product was drumdried.

### EXAMPLE 1F

Synthesis of the Bridging Solid CTS2

Tapioca starch was cross-linked in a 39% suspension in water containing NaCl with sodium trimetaphosphate (100 g/kg) at 35° C. using NaOH as catalyst. The resulting product was drumdried.

### EXAMPLE 1G

Synthesis of the Bridging Solid CTS3

Tapioca starch was cross-linked in a 39% suspension in water containing NaCl with epichlorohydrin (100 g/kg) at 35° C. using NaOH as catalyst. The resulting product was drumdried.

### EXAMPLE 2

Degradation of the bridging agent FCS, FCGS (prepared according to Examples 1A and 1B) and CaCO₃.

5 gram of the products were dispersed in water in a concentration of 10%. With NaOH and HCl or citric acid the dispersion was brought to the desired pH. After 24 hours at 75° C. the solubility was measured with an ATAGO RX-1000 Digital Refractometer and combined with visual judgment. The results in table 1 show that FCS and FCFS have dissolved at pH 2 and remain largely insoluble at pH 10, whilst the reference material remains insoluble under these conditions. An additional comparison was made with native potato starch (NPS), which dissolves at each pH studied.

TABLE 1

| | Solubility (%) | | | | | |
|---|---|---|---|---|---|---|
| | after 24 hours 75° C. | | | | | |
| Product | pH 2 | Visual | pH 3.3 | Visual | pH 10 | visual |
| FCS | 100 | no particles | 5.5 | some | 0 | particles |
| | | | | particles | | |
| FCGS | 100 | no particles | 20 | some | 13.5 | particles |
| | | | | particles | | |
| CaCO₃ | 0 | particles | 0 | particles | 0 | particles |
| NPS | 100 | no particles | 100 | no particles | 100 | no |
| | | | | | | particles |

### EXAMPLE 3

The bridging agents prepared in Examples 1A and 1B were evaluated in the following drilling fluids:

TABLE 2

| | Amount (g) | | | | |
|---|---|---|---|---|---|
| Component | Fluid A | Fluid B | Fluid C | Fluid D | Fluid E |
| Demineralized | 350 | 350 | 350 | 350 | 350 |
| water | | | | | |
| KCl | 43 | 43 | 43 | 43 | 43 |
| Mg(OH)₂ | 1 | 1 | 1 | 1 | 1 |
| CaCO₃ | 40 | — | — | 20 | 40 |
| FCS | — | 20 | — | — | — |
| FCGS | — | — | 20 | 20 | — |
| NPS | — | — | — | — | 20 |
| APEC HT | 6 | 0 | 3 | 3 | 1 |
| Xanthan gum | 1 | 1 | 1 | 1 | 6 |

Demineralized water, KCl, Mg(OH)₂, and bridging solid were mixed for 10 minutes, a commercially available colloidal polymer APEC HT (AVEBE) was added to the fluid and mixed for 10 minutes.

Finally xanthan gum was added and the fluid was mixed for another 10 minutes.

The drilling fluids were evaluated after ageing for 16 hours, either static at 25° C. or after hot rolling at 80° C.

Viscosities were measured using a Fann Viscometer Model 35SA, spring F1. The readings was collected at 600 rpm. The filtrate was collected during 30 minutes at 100 psi. Fluid loss was recorded according to API Specification 13A, Section 11 Starch.

TABLE 3
The fluids after ageing at 25° C.

| | | Fann 600 | | Fluid loss |
|---|---|---|---|---|
| Fluid | Bridging agent | (readings) | pH | (ml) |
| A | CaCO₃ | 75 | 10.1 | 6 |
| B | FCS | 80 | 9.9 | 27 |
| C | FCGS | 62 | 10.0 | 4.4 |
| D | FCGS and CaCO₃ | 65 | 10.0 | 4.3 |
| E | NPS | 80 | 10 | 30 |

Fluid C shows that good rheology and filtration control can be obtained by utilizing FCGS.

Fluid C containing FCGS gives better filtration control than Fluid B and Fluid E containing FCS and NPS, respectively, showing a gelatinized particle is yielding better bridging characteristics than a crystalline particle.

TABLE 4
Fluids containing CaCO₃ or FCGS after dynamic aging

| | Bridging | Hot rolling | Fann 600 | fluid loss |
|---|---|---|---|---|
| Fluid | agent | (° C.) | (readings) | (ml) |
| A | CaCO₃ | 25 | 60 | 6.2 |
| A | CaCO₃ | 80 | 75 | 5.7 |
| C | FCGS | 25 | 62 | 4.4 |
| C | FCGS | 80 | 79 | 3.7 |

TABLE 5
The fluids after aging at pH 2 for 24 hours

| | Bridging | Fluid loss after |
|---|---|---|
| Fluid | agent | 24 h at pH 2 (ml) |
| A | CaCO₃ | 30 |
| A | CaCO₃ | 30 |
| C | FCGS | Total |
| C | FCGS | Total |

The results in table 4 shows that the optimized fluid has good properties at 25° C. and after hot rolling at 80° C. compared to a fluid with CaCO₃. Table 6 shows that fluid C containing FCGS is fully degraded after inclusion of acid for 24 hours, the CaCO₃ containing fluid a is not completely degraded.

### EXAMPLE 4

Samples of the materials prepared according to Example 1A, 1B, and 1C were dispersed in cold water and stirred for 1 hour. Afterwards the viscosity was measured. One dispersion containing FCS was heated to 95° C. to gelatinize the starch (FCS2), the other one remained ungelatinized (FCS1). The FCGS sample was mixed in a weight ratio of 4:1 with pregelatinized potato starch (FGCS*).

Two reference materials were studied: Pregelatinized potato starch which was not cross-linked (Ref1) and cross-linked pregelatinized potato starch according to Example 1D (VSCS), the latter being cross-linked to a level at which the maximum viscosity is obtained.

The viscosities of these four materials were determined (Brookfleld RVT at 20 rpm, 25° C.) in suspensions containing different amounts of the materials (1, 2, 4, 6, 8, 10, 15, 20, 25, and 30%). The results show that the heavily cross-linked products according to the invention are cross-linked to a level far beyond the level at which the maximum viscosity is reached. In concentrations of 1-15% little viscosity is generated compared to the reference materials.

TABLE 6

| Product | 1% | 2% | 4% | 6% | 8% | 10% | 15% | 20% | 25% | 30% |
|---|---|---|---|---|---|---|---|---|---|---|
| FCS1 | — | — | — | — | — | — | — | — | — | <20 |
| FCS2 | — | — | — | — | — | <20 | 35 | 865 | 1380 | >100.000 |
| FCGS* | — | — | — | — | <20 | 88 | 288 | 7000 | >100.000 | — |
| Ref1 | <20 | 60 | 278 | 874 | 2520 | 45000 | >100.000 | — | — | — |
| VSCS | <20 | 26 | 1100 | 18700 | 43000 | 94800 | >100.000 | — | — | — |

### EXAMPLE 5

Samples of the materials prepared according to example 1A, 1C, 1D and 1 reference material from example 4 were suspended in water in a concentration of 10 wt. % (calculated on the weight of the suspension). The suspensions (100 ml each time) were heated to 95° C. whilst stirring and poured into measuring cylinders. After 24 hours the amount of sediment, the setting volume, was measured in ml.

TABLE 7

| Product | Setting volume |
|---|---|
| FCS | 40 |
| SCS | 60 |
| VSCS | 100 |
| Ref1 | 100 |

### EXAMPLE 6

Degradation of the bridging agents CTS1, CTS2 and CTS3

5 gram of the products was dispersed in water in a concentration of 10%. With NaOH and HCl (18.5%) the dispersion was brought to the desired pH. After 24 hours and after 2 weeks the solubility was measured with an ATAGO RX-1000 Digital Refractometer and combined with visual judgement.

The results in table 8 show that CTS 1 and 2 have dissolved completely at pH 2 after 24 hours. CTS3 has dissolved completely within 2 weeks.

TABLE 8

| | Solubility (%) | | | | Solubility (%) | | | |
|---|---|---|---|---|---|---|---|---|
| | after 24 hours 75° C. | | | | after 2 weeks 75° C. | | | |
| Product | pH 2 | Visual | pH 10 | Visual | pH 2 | Visual | pH 10 | Visual |
| CTS1 | 100 | no particles | 11 | particles | 100 | no | 14 | particles |
| | | | | | | particles | | |
| CTS2 | 100 | no particles | 13 | particles | 100 | no | 17 | particles |
| | | | | | | particles | | |
| CTS3 | 57 | some particles | 9 | particles | 100 | no | 23 | particles |
| | | | | | | particles | | |

### EXAMPLE 7

The bridging solids prepared in example 1E-1G were evaluated in the fluids described in table 9, according to the method described in example 3. The commercially available colloidal polymer Flocgel RD for the experiments replaced APEC HT.

TABLE 9

| Product | Fluid F | Fluid G | Fluid H | Fluid I |
|---|---|---|---|---|
| Water | 350 | 350 | 350 | 350 |
| KCl | 43 | 43 | 43 | 43 |
| MgO | 1 | 1 | 1 | 1 |
| Flocgel RD | 6 | 3 | 3 | 3 |
| Xanthan gum | 1 | 1 | 1 | 1 |
| CaCO₃ | 40 | 0 | 0 | 0 |
| CTS 1 | 0 | 20 | 0 | 0 |
| CTS 2 | 0 | 0 | 20 | 0 |
| CTS 3 | 0 | 0 | 0 | 20 |

TABLE 10
The fluids after ageing at 25° C.

| | Bridging | Fann 600 | | |
|---|---|---|---|---|
| Fluid | agent | (readings) | pH | Fluid loss |
| F | CaCO₃ | 53 | 10.9 | 6.6 |
| G | CTS 1 | 66 | 10.9 | 3.9 |
| H | CTS 2 | 60 | 11.0 | 4.1 |
| I | CTS 3 | 58 | 10.6 | 4.4 |

The fluids G-I show better filtration control than the reference F.

TABLE 11
The fluids after ageing at 80° C.

| | Bridging | Fann 600 | | |
|---|---|---|---|---|
| Fluid | agent | (readings) | PH | Fluid loss |
| F | CaCO₃ | 55 | 10.5 | 6.7 |
| G | CTS 1 | 82 | 10.3 | 4.0 |
| H | CTS 2 | 84 | 10.3 | 4.1 |
| I | CTS 3 | 55 | 10.4 | 4.0 |

The fluids show good filtration control. Fluids G and H show a slight increase in viscosity.

TABLE 12
The fluids after ageing at pH 1 for 24 hours at 80° C.

| | Bridging | HCl needed to | Fluid |
|---|---|---|---|
| Fluid | agent | reach pH 1 (ml) | loss |
| F | CaCO₃ | 77.8 | Total |
| G | CTS 1 | 8.1 | Total |
| H | CTS 2 | 8.5 | Total |
| I | CTS 3 | 8.3 | Total |

The results in table 12 show that substantially less acid is needed to reach a pH of 1 when CTS1 CTS2 or CTS3 are used in a drilling fluid compared to the use of the reference CaCO₃.

Legend of the Figures

The microscope photographs 1-3 shows drilling fluids with CaCO₃, FCS and FCGS.
Photograph 1. shows drilling fluid A containing CaCO₃ fine dispersed.
Photograph 2. shows drilling fluid B containing FCS. The polarization cross indicates that FCS is crystalline.
Photograph 3. shows drilling fluid C containing FCGS, present in the drilling fluid as slightly swollen, non-crystalline or amorphous cross-linked starch particles.
Photograph 4. shows filter cakes from fluids with CaCO₃ (right) and FCGS (left).

1. A bridging agent for a drilling fluid based on a polysaccharide which is cross-linked to such a degree that after gelatinization it forms solid particles which are substantially insoluble in water.

2. A bridging agent according to claim 1, wherein the polysaccharide is chose from the group of cellulose, starch, tamarind, guar gum, and locust bean gum.

3. A bridging agent according to claim 2, wherein the polysaccharide is chosen from the group of potato starch, corn starch, tapioca starch, wheat starch, rice starch, waxy corn starch, amylopectin potato starch, amylopectin tapioca starch, and waxy wheat starch.

4. A bridging agent according to claim 1, wherein the polysaccharide is cross-linked with a trimetaphosphate salt, epichlorohydrin, phosphorous oxychloride, dimethylolethylene urea, adipic anhydride, or dichloro acetic acid.

5. A bridging agent according to claim 1, wherein the polysaccharide is hydroxyalkylated or carboxylated.

6. A bridging agent according to claim 1, in gelatinized form.

7. A bridging agent according to claim 1, wherein the polysaccharide is cross-linked to a degree such that the setting volume of less than 70 ml in 10% by weight (calculated on the suspension) suspension of the cross-linked polysaccharide.

8. A method for preparing a bridging agent according to claim 7 comprising cross-linking a polysaccharide to a degree sufficient to obtain a setting volume of less than 70 ml in 10% by weight (calculated on the suspension) suspension of the cross-linked polysaccharide.

9. A drilling fluid comprising a bridging agent according to claim 1.

10. A drilling fluid according to claim 9 further comprising a viscosifier, and a fluid loss control additive.

11. A drilling fluid according to claim 10 further comprising an alkaline buffer.

12. A method for drilling a well into a subterranean formation for the purpose of extracting or producing a mineral contained by the formation comprising forming a borehole by drilling and forming a filter cake to provide a sealing layer on the walls of said borehole by applying a drilling fluid according to claim 9.

13. A filter cake on the walls of a borehole in a subterranean formation formed in a method according to claim 12.

14. A method for removing a filter cake according to claim 13 by washing with a washing fluid.

15. A method according to claim 14, wherein the washing fluid is an aqueous solution of an acid chosen from the group of strong mineral acids, citric acid, lactic acid, malic acid, acetic acid, formic acid, and combinations thereof.

16. A method according to claim 15, wherein the pH of the washing fluid is below 4.

17. A method according to claim 14, wherein the washing fluid comprises a carbohydrate degrading enzyme.

18. A method according to claim 14, wherein the washing fluid comprises an oxidizing agent.
